(19) United States
(12) Patent Application Publication
(10) Pub. No.: US 2026/0045506 A1
(43) Pub. Date: Feb. 12, 2026

(54) Cathode and Lithium-Ion Battery Comprising the Cathode

(71) Applicant: Bayerische Motoren Werke Aktiengesellschaft, Muenchen (DE)

(72) Inventors: Sung-Jin KIM, Muenchen (DE); Thomas WOEHRLE, Muenchen (DE)

(21) Appl. No.: 18/997,881

(22) PCT Filed: Jul. 12, 2023
(86) PCT No.: PCT/EP2023/069348

§ 371 Date: Jan. 23, 2025

(30) Foreign Application Priority Data
Jul. 25, 2022 (DE) 10 2022 118 484.6

(51) Int. Cl. H01M 4/62; H01M 4/02; H01M 4/131; H01M 4/136; H01M 4/505; H01M 4/525; H01M 10/0525

(52) U.S. Cl. CPC H01M 4/623; H01M 4/131; H01M 4/136; H01M 4/505; H01M 4/525; H01M 4/625; H01M 10/0525; H01M 2004/021; H01M 2004/028

(57) ABSTRACT

Cathodes for a lithium-ion battery are provided, the cathode comprising the following components: (A) at least one cathode active material; and (B) at least one electrode binder; the cathode active material of the component (A) being in the form of particles on the surfaces of which at least some of the electrode binder of the component (B) is covalently bonded. Lithium-ion batteries comprising the cathodes are further provided.

### BACKGROUND AND SUMMARY

The present disclosure relates to a cathode and to a lithium ion battery comprising the cathode.

The term “lithium ion battery” is used synonymously hereinafter for all terms for lithium-containing galvanic elements and cells that are commonly used in the art, for example lithium cell, lithium ion cell, lithium polymer cell and lithium ion accumulator. In particular, rechargeable batteries (secondary batteries) are included. The terms “battery” and “electrochemical cell”are also used synonymously with the term “lithium ion battery”.

A lithium ion battery comprises a positive electrode (cathode) and a negative electrode (anode). The cathode has a cathode active material capable of reversibly accepting and releasing lithium ions. In order to assist the acceptance and release of lithium ions in the cathode active material and to further improve the properties of the composite cathode, additives are generally added to the composite cathode, such as electrode binders and electrically conductive additives, for example carbon black and optionally dispersers. The cathode active material is present in a composite together with the additives, in other words, a blend applied to a cathode current collector manufactured from aluminum. Such a cathode is also known in the art as a composite cathode.

The composition of the cathode is an important aspect for the cell chemistry of the lithium ion battery. In particular, the selection and composition of the composite may be crucial in establishing particular electrochemical properties (such as high-current durability or cycling stability, lifetime) of the lithium ion battery.

For the production of such a composite electrode, it is first necessary to produce a coating composition (cathode slurry). This comprises a homogeneous mixture of cathode active material, electrode binder, conductivity additive, optionally further additives and a carrier solvent. Such a coating composition is applied to the cathode current collector and dried. During the drying process, the carrier solvent present (for example NMP or water) is removed, forming a composite on the surface of the current collector.

In order to improve the electrochemical properties of a cathode and hence also a lithium ion battery and to achieve a certain high-current durability and cycling stability, it is desirable to achieve a homogeneous distribution of the individual constituents in the composite. However, there are various aspects that make it difficult to achieve homogeneous distribution of the individual constituents in the composite, for example the use of an inhomogeneous coating composition for production of the composite or an unadjusted drying profile during the drying of the coating composition. Inhomogeneous distribution of the constituents in the composite has an adverse effect on the lifetime, reliability and electrochemical properties of the cathode, and hence also on a lithium ion battery produced therefrom.

In this respect, it is the object of the present disclosure to provide a cathode which is easy and inexpensive to produce and meets the electrochemical performance requirements made for use in a lithium ion battery.

The object is achieved in accordance with the present disclosure by a cathode for a lithium ion battery.

Advantageous embodiments of the cathode of the invention are further specified and may be selectively combined with one another.

According to the present disclosure, the object is achieved by a cathode for a lithium ion battery, wherein the cathode comprises the following components:
(A) at least one cathode active material; and
(B) at least one electrode binder;
wherein the cathode active material of component (A) takes the form of particles with at least a portion of the electrode binder of component (B) in covalently bonded form on the surface thereof.

### DETAILED DESCRIPTION

The present disclosure is based on the basic concept of direct chemical linkage between the electrode binder and the cathode active material, such that the electrode binder is fixed on the surface of the cathode active material. In other words, the particles of the cathode active material are surface-functionalized by the electrode binder.

Moreover, it is advantageously no longer necessary in the production of the coating composition, as has been customary to date, to produce a separate electrode binder solution and mix the separate electrode binder solution with the cathode active material and vigorously if necessary with carbon black; instead, the cathode active material can be functionalized with the electrode binder in advance and be stored as surface-functionalized cathode active material powder. In the production of the coating composition, the powder with the surface-functionalized cathode active material particles can then merely be weighed out in a single step with the other additives and then suspended together in the solvent. In this way, the process steps needed for slurry production can be reduced, which accelerates and simplifies the production process overall. Consequently, time and resources are saved in the course of production, which makes the cathode itself less costly as well.

Furthermore, the homogeneity of the composite is also improved, because the electrode binder and the cathode active material already take the form of a homogeneous unit. It is thus possible to distinctly increase the lifetime, reliability, and high-current durability of the cathode.

According to the present disclosure, the cathode comprises at least one cathode active material as component (A). Fundamentally, the cathode active material of component (A) is unrestricted, and it is possible to use any cathode active material known in the art that is capable of forming the cathode for a lithium ion battery.

Suitable cathode active materials for the cathode may therefore be any of the cathode active materials known in the art that can reversibly accept and release lithium ions. In particular, it is possible to use cathode active materials as disclosed in the scientific article by D. Andre et al. (J. Mater. Chem. A, 2015, 3, 6709-6732). [1]

In a first aspect, the cathode active material is selected from the group consisting of lithium cobalt oxide (LCO), lithium nickel oxide (LNO), lithium nickel cobalt aluminum oxide (NCA), lithium nickel manganese cobalt oxide (NMC), lithium nickel manganese oxide (NMx), lithium-and manganese-rich lithium nickel manganese cobalt oxide or lithium nickel manganese oxide (LMR), lithium manganese oxide (LMO), lithium iron phosphate (LFP), lithium manganese iron phosphate (LMFP), lithium nickel manganese oxide spinel (LNMO) and derivatives and combinations thereof.

Lithium nickel manganese cobalt oxide compounds are also known by the abbreviation NMC, and occasionally also alternatively by the technical abbreviation NCM. NMC-based cathode active materials are especially used in lithium ion batteries for electrical vehicles. NMC as cathode active material has an advantageous combination of desirable properties, for example high specific capacity, a reduced cobalt content, high high-current capacity and high intrinsic safety, which is manifested, for example, in adequate stability in the event of an overload.

NMC can be described by the general formula unit Li_{α}NiₓMn_{y}Co_{z}O₂ with x+y+z=1, where a denotes the figure for the stoichiometric proportion of lithium and is typically between 0.8 and 1.15. Particular stoichiometries are reported in the literature as three-figure numbers, for example NMC-811, NMC-622, NMC-532 and NMC-111. The three-figure number in each case indicates the relative content of nickel: manganese: cobalt. In other words: for example, NMC-811 is a cathode active material having the general formula unit LiNi_{0.8}Mn_{0.1}Co_{0.1}O₂, in other words, with α=1. In addition, it is also possible to use the lithium-and manganese-rich NMCs mentioned with the general formula unit Li_{1+E}(NiₓMn_{y}CO_{z})_{1-E}O₂, where E is in particular between 0.1 and 0.6, preferably between 0.2 0.4. The silicon-rich layered oxides are also known as overlithiated (layered) oxides (OLOs).

As already described above, the cathode active material is in the form of particles with the electrode binder (B) in covalently bonded form on the surface thereof. The particles of the cathode active material may have a particle size distribution having an average particle diameter within a range from 0.01 μm to 30 μm, preferably from 50 nm to 1000 nm. The particle diameter can be determined by electron micrographs (TEM, SEM) or by dynamic light scattering (DLS). The average particle diameter is measured here without the electrode binder.

As well as the at least one cathode active material, the cathode, according to the present disclosure, comprises at least one electrode binder of component (B) at least partly in covalently bonded form on the surface of the cathode active material.

An electrode binder is understood hereinafter to mean a filler having adhesion-promoting capacity, such that it holds the other constituents of the cathode together. In this respect, the electrode binder of component (B) is unrestricted, and it is possible in principle to use any electrode binder from the art which is capable of acting as electrode binder in a cathode for a lithium ion battery.

The electrode binder may especially be a polymer. For example, the electrode binder may be a non-fluorinated polymer selected from the group consisting of hydrogenated acrylonitrile-butadiene rubber (HNBR), carboxymethylcellulose (CMC), styrene-butadiene rubber (SBR), polyacrylate (PAA) and polyvinylalcohol (PVA), polyvinylpyrrolidone (PVP) and combinations thereof.

Alternatively, the electrode binder may be a fluorinated polymer having a base skeleton G. In principle, the base skeleton G may comprise an aliphatic, at least partly fluorinated hydrocarbon skeleton that may be linear, cyclic or branched.

In one embodiment, the base skeleton G of the fluorinated polymer is at least partly fluorinated and has a repeat unit selected from the group consisting of vinylidene fluoride (—CH₂CF₂—) and hexafluoropropylene (—CF₂CF(CF₃)—). Also conceivable is a combination of the different units. These may also be tetrafluoroethylene (—CF₂—CF₂—) units. PTFE electrode binders themselves are known, for example, from US 2013 157 141 A1.

The fluorinated polymer having the base skeleton G may have a molar mass Mw within a range from 100 to 2000 kDa, preferably from 500 to 1500 kDa.

The fluorinated polymer having the base skeleton G may have additional polar groups, such as maleic anhydride or else free acid groups, especially in the case of PVdF. Such polar-modified PVdF electrode binders are known from EP 2 147 029 B1.

For example, the fluorinated polymer may be a polymer selected from the group consisting of polyvinylidene fluoride (PVDF) and poly(vinylidene fluoride-hexafluoropropylene) copolymer (PVDF-HFP).

Fluorinated polymers used may, for example, be homo-or copolymers from Solef®, such as Solef® 5130 (homopolymer), Solef® 21216 (PVdF-HFP). It is likewise possible to use fluorinated polymers from Kureha®, such as the KF polymer series, or else from Arkema, such as the Kynar® polymer series.

The abovementioned electrode binders have high affinity for the conductivity additives such as carbon black that are often included in cathodes. As a result, the electrode binders bound to the surface of the cathode active material can interact with and physically bind the conductivity additives, which gives rise to a fixed composite composed of cathode active material, electrode binder and conductivity additive. Consequently, the constituents are also distributed homogeneously in the cathode composite.

In another aspect, the base skeleton G has been modified with at least one radical, one heteroatom, one side chain, or one functional group.

The radical may be a linear, branched, or cyclic C₁-C₁₀ perfluoroalkyl radical.

The expression C₁-C₁₀ perfluoroalkyl in the context of the present disclosure encompasses linear, branched, or branched saturated perfluorinated hydrocarbyl radicals having 1 to 10 carbon atoms.

Examples of suitable perfluoroalkyl radicals are trifluoromethyl, perfluoroethyl, perfluoropropyl, perfluoroisopropyl, perfluoro-n-butyl, perfluoro-sec-butyl, perfluoroisobutyl, and perfluoro-tert-butyl.

The heteroatom may be in a bridging arrangement between two repeat units and join these to one another, where the heteroatom is selected from the group consisting of an element of groups 15 and 16 of the Periodic Table.

The heteroatom used may, for example, be an oxygen atom or a nitrogen atom.

The side chain may be selected from the group consisting of acrylonitrile-butadiene rubber (HNBR), carboxymethylcellulose (CMC), styrene-butadiene rubber (SBR), polyacrylate (PAA), polyvinylpyrrolidone (PVP), and polyvinylalcohol (PVA).

The functional group may be selected from the group consisting of hydroxide, amine, carboxylic acid, ketone, anhydrides (for example, maleic anhydride), and sulfoxide.

The modifications to the base skeleton G with a radical, a heteroatom, a side chain, or a functional group that are described here serve primarily to increase the affinity of the electrode binders for the conductivity additive. In addition, it is thus also possible to adjust the electrochemical properties of the cathode formed therefrom.

In a further aspect of the invention, the electrode binder (B) is covalently bonded to the surface of component (A) via an anchor group. An anchor group generally means a chemical group that anchors, in other words, covalently binds, the electrode binder on the surface of the cathode active material.

As already described above, at least a portion of the electrode binder of component (B) is covalently bound on the surface of the cathode active material of component (A), where the electrode binder is covalently bound to the surface by means of the anchor group. The portion of the electrode binder of component (B) that is not bound to the surface of the cathode active material particles may electively have an anchor group.

In principle, the anchor group is unrestricted in chemical terms, and it is possible to use any desired chemical group from the art which is capable of covalently binding the oxidic surface of the cathode active material to the electrode binder.

The anchor group is preferably selected from the group consisting of an amide group, amine group, alkyne group, alkene group, hydroxide group, carboxylate group, ether group, phosphonate group, silane group, silyl group, siloxane group, halosilane group, carbamoyl group, sulfo group, carboxylic anhydride group, and sulfonamide group.

In a further aspect of the present disclosure, the electrode binder (B) at least partly, preferably fully, covers the surface of a particle of the cathode active material. If the electrode binder (B) fully covers the surface of a particle of the cathode active material, the electrode binder may also be regarded as a coating that encases the particles of the cathode active material (A).

In one variant, the particles of the cathode active material have an average degree of coverage of 0.005 to 0.1 g of electrode binder per 0.05 to 0.9 m² of surface area of the cathode active material. The stated range preferably applies to cathode active materials having a particle diameter in the micrometer range (≥1 μm), for example NCM or LCO.

In another variant, the particles of the cathode active material have an average degree of coverage of 0.05 to 1 g of electrode binder per 10 to 15 m² of surface area of the cathode active material. The stated range preferably applies to cathode active materials having a particle diameter in the nanometer range and/or a specific surface area of 10-15 m²/g, for example nano-LFP.

It is also conceivable that there is a mixture of two or more electrode binders each having different anchor groups on a particle of the cathode active material. Depending on the proportion of the electrode binders in the mixture, it is thus possible to adjust the electrochemical properties of the resultant cathode.

In a further aspect, the cathode further comprises at least one conductivity additive (C). The conductivity additive is selected from the group consisting of conductive carbon black, carbon nanotubes (CNTs), graphene, graphite, expanded graphite, carbon nanofibers, especially gas-phase-produced carbon nanofibers (VGCF), and combinations thereof.

Advantageously, the combination of a conductivity additive (C) and an electrode binder (B) bound to the surface of a cathode active material (A) enables the production of a particularly high-performance cathode for a lithium ion battery, because the conductivity additives (C) used especially increase the electrical conductivity of the cathode. Furthermore, a synergistic effect between the electrode binder and the conductivity additive can be achieved since the electrode binder (B) has particular affinity for the conductivity additive (C), binds thereto, and hence brings the conductivity additive into the proximity of the cathode active material (A), on the surface of which the electrode binder (B) itself is bound.

In another aspect of the present disclosure, the cathode further comprises one or more additives (D). The one or more additives (D) are selected from the group consisting of binding aids, fillers, dispersers and additional adhesion promoters, such as acrylates or methacrylic acid.

A binding aid hereinafter is understood to mean compounds and substances that act in the same way as the electrode binder (B), in other words, have affinity for the conductivity additives and keep the composition of the cathode together, but are not bound to the surface of the cathode active material. Instead, binding aids are in essentially unbound form in the composite.

In another aspect, the cathode comprises the following components, based in each case on the total weight of the cathode:
(A) 80-99% by weight, preferably from 90% to 98% by weight, of at least one cathode active material, where the cathode active material is selected from the group consisting of lithium cobalt oxide (LCO), lithium nickel oxide (LNO), lithium nickel cobalt aluminum oxide (NCA), lithium nickel manganese cobalt oxide (NMC), lithium-and manganese-rich lithium nickel manganese cobalt oxide or lithium nickel manganese oxide (LMR), lithium manganese oxide (LMO), lithium iron phosphate (LFP), lithium manganese iron phosphate (LMFP), lithium nickel manganese oxide spinel (LNMO), and derivatives and combinations thereof;
(B) 0.5-3% by weight, preferably from 1% to 2% by weight, of at least one electrode binder;
(C) 0.05-5% by weight, preferably 0.5% to 3% by weight, of at least one conductivity additive, where the conductivity additive is selected from the group consisting of conductive carbon black, carbon nanotubes (CNTs), graphene, graphite, expanded graphite and carbon nanofibers, especially gas-phase-produced carbon nanofibers (VGCF), and combinations thereof; and
(D) 0-10% by weight, preferably from 0.1% to 1% by weight, of at least one additive selected from the group consisting of binding auxiliary, filler, disperser and adhesion promoter, and combinations thereof, where the proportions of components (A) to (D) add up to 100 percent.

Such a cathode has particularly good electrode and cell properties.

The present disclosure further relates to a lithium ion battery having a cathode as described above.

The present disclosure is based on the basic concept of particularly homogeneous blending of the components of the cathode with one another, which is achieved in particular in that at least a portion of the electrode binder is covalently bound on the surface of the cathode active material. In this way, it is possible in particular to avoid various drying phenomena in the production of the cathode or of the lithium ion battery, such that the lithium ion battery of the present disclosure has particularly good high-current durability and cycling stability.

The lithium ion battery, as well as the cathode as described above, comprises an anode and an electrolyte composition which is in contact with the cathode and the anode.

The anode is fundamentally unrestricted, and it is possible to use any of the anodes for lithium ion batteries that are known in the art.

The anode preferably includes an anode active material. In particular, the anode active material may be selected from the group consisting of carbon-containing materials, silicon, silicon suboxide, silicon alloys, lithium, lithium alloys, aluminum alloys, indium, indium alloys, tin, tin alloys, cobalt alloys, niobium pentoxide, titanium dioxide, titanates, for example lithium titanate (Li₄Ti₅O₁₂), tin dioxide, and mixtures thereof.

More preferably, the anode active material is selected from the group consisting of synthetic graphite, natural graphite, graphene, mesocarbon, doped carbon, hard carbon, soft carbon, fillers, silicon-carbon composite, silicon, surface-coated silicon, silicon suboxide, silicon alloys, lithium, aluminum alloys, indium, tin alloys, cobalt alloys, and mixtures thereof.

In addition to the anode active material, the anode may include further components and additives, for example a film carrier, an electrode-electrode binder and/or an electrical conductivity improver, for example conductive carbon black, conductive graphite, carbon nanotubes (CNTs), carbon fibres and/or graphene. Further components and additives used may be any of the customary compounds and materials that are known in the prior art.

The electrolyte composition is likewise unrestricted.

For example, the electrolyte composition may include a dialkyl carbonate, especially a dialkyl carbonate selected from the group consisting of diethyl carbonate (DEC), dimethyl carbonate (DMC) or ethyl methyl carbonate (EMC), and combinations thereof.

As a further component, the electrolyte composition preferably comprises at least one lithium salt, preferably selected from the group consisting of lithium hexafluorophosphate (LiPF₆), lithium bis(fluoromethane-sulfonyl)imide (LiFSI), and lithium bis(trifluoromethane-sulfonyl)imide (LiTFSI), and combinations thereof.

### EXAMPLES

Various illustrative compositions for cathodes are specified hereinafter.

The compositions specified are merely by way of example and should not be interpreted in a limiting sense.

### Example Composition 1

PVDF base skeleton+silane anchor group+LiNi_{0.8}Co_{0.1}Mn_{0.1}O₂ (NCM811) cathode active material.

### Example Composition 2

Poly(vinylidene fluoride-hexafluoropropylene) copolymer (PVDF-HFP) base skeleton+phosphonate anchor group+LiFePO4 cathode material.

### Production of Surface-modified Cathode Active Material Particles

The cathode active material of component (A) may be purchased commercially. The cathode active material is preferably already used in powder form with the appropriate particle size distribution.

The cathode active material of component (A) and the electrode binder are then converted to surface-modified cathode active material particles by a chemical reaction. For this purpose, it is possible to use a process as disclosed in the scientific article by F. Ahangaran et al. “Recent advances in chemical surface modification of metal oxide nanoparticles with silane coupling agents: A review” (Advances in colloid and interface science, volume 286, December 2020, 102298).

### Reaction Example 1

For example, a fluorinated polymer having a base skeleton G provided with a silanol function can react with the oxidic surface of the cathode active material with elimination of water and to obtain surface-modified cathode active material particles. The reaction gives rise to an anchor group in the form of a silyl group that covalently binds the base skeleton G of the fluorinated polymer to the surface of the cathode active material.

### Reaction Example 2

In one variant, it is alternatively possible to use a fluorinated polymer having a base skeleton G provided with a silicon-halogen group (X₃—Si—G). A reaction with the oxidic surface (—OH) with elimination of hydrogen chloride gives a silyl anchor group (O—Si—G) that covalently binds the base skeleton G of the fluorinated polymer to the surface of the cathode active material. Reference is made by way of example to WO 2005/06131 A2.

### Reaction Example 3

In a further variant, a fluorinated polymer having a base skeleton G having a phosphonic acid can react with the oxidic surface of a cathode active material. A phosphonate group is then formed as anchor group on the surface of the cathode active material, and this covalently binds the oxidic surface of the cathode active material to the G of the fluorinated polymer.

### Production of the Cathode Slurry and the Cathode

The production of the cathode slurry and of the cathode is elucidated in detail hereinafter.

The production process for the cathode slurry and the cathode as specified here should be considered to be purely illustrative. The cathode can in principle be produced via various methods that are known in the art.

First of all, the surface-modified cathode active material particles are produced as already described above.

Next, the surface-modified cathode active material particles are weighed out together with the conductive carbon black and with other additives and suspended in a carrier solvent. The carrier solvent may, for example, be N-methyl-2-pyrrolidone (NMP). However, it is also possible to use other organic solvents such as acetone, but also water-based solvents. Since the electrode binder is bound to the cathode active material, there is advantageously no need to predissolve the electrode binder in the carrier solvent.

The suspension is stirred until it is homogeneous. What is formed is a homogeneous cathode coating composition (cathode slurry). The viscosity of the cathode coating composition is preferably adjusted to 5 to 20 Pa s⁻¹, which is referred to as target viscosity. The viscosity can be adjusted via addition or via evaporation of the carrier solvent.

In the next step, the cathode coating composition is applied to a current collector with a coating bar or a slot die. For the production of a cathode, the current collector typically consists of an aluminum foil.

Finally, the current collector with the cathode coating composition applied is dried. The drying converts the moist coating composition to a dry composite. After drying and calendering (pressing), the cathode of the present disclosure is obtained.

The cathode preferably has a weight per unit area of 18 mg/cm² and electrode density of 3.4 g/cm³.

The cathode thus produced has a homogeneous distribution of cathode active material, conductivity additive and electrode binder, and is therefore especially suitable for incorporation into a lithium ion battery.

1-10. (canceled)

11. A cathode for a lithium ion battery, comprising:
(A) at least one cathode active material; and
(B) at least one electrode binder;
wherein the cathode active material is in a form of particles with at least a portion of the electrode binder of component covalently bonded to the surface thereof.

12. The cathode for a lithium ion battery according to claim 11, wherein the cathode active material is selected from the group consisting of lithium cobalt oxide (LCO), lithium nickel oxide (LNO), lithium nickel cobalt aluminum oxide (NCA), lithium nickel manganese cobalt oxide (NMC), lithium nickel manganese oxide (NMx), lithium-and manganese-rich lithium nickel manganese cobalt oxide or lithium nickel manganese oxide (LMR), lithium manganese oxide (LMO), lithium iron phosphate (LFP), lithium manganese iron phosphate (LMFP), lithium nickel manganese oxide spinel (LNMO), derivatives thereof, and combinations thereof.

13. The cathode for a lithium ion battery according to claim 11, wherein the electrode binder of component (B) is a fluorinated polymer having a base skeleton G containing at least one repeat unit selected from the group consisting of vinylidene fluoride (—CH₂CF₂—), tetrafluoroethylene (—CF₂—CF₂—), and hexafluoropropylene (—CF₂CF(CF₃)—).

14. The cathode for a lithium ion battery according to claim 13, wherein the base skeleton G has been modified with at least one radical, one heteroatom, one side chain, and/or one functional group,
wherein the radical is a linear, branched, or cyclic C₁-C₁₀ perfluoroalkyl radical,
wherein the heteroatom is in a bridging arrangement between two repeat units and joins the two repeat units, and wherein the heteroatom is selected from the group consisting of an element of group 15 of the Periodic Table, and an element of 16 of the Periodic Table,
wherein the side chain is selected from the group consisting of acrylonitrile-butadiene rubber (HNBR), carboxymethylcellulose (CMC), styrene-butadiene rubber (SBR), polyacrylate (PAA), polyvinylpyrrolidone (PVP), and polyvinylalcohol (PVA),
and wherein the functional group is selected from the group consisting of hydroxide, amine, carboxylic acid, ketone, anhydride, and sulfoxide.

15. The cathode for a lithium ion battery according to claim 11, wherein the electrode binder (B) is covalently bonded to the surface of component (B) via an anchor group.

16. The cathode for a lithium ion battery according to claim 15, wherein the anchor group is selected from the group consisting of amide group, hydroxide group, carboxylate group, ether group, phosphonate group, silane group, silyl group, siloxane group, halosilane group, carbamoyl group, sulfo group, sulfonamide group, carboxylic anhydride group, amine group, alkyne group, and alkene group.

17. The cathode for a lithium ion battery according to claim 11, wherein the electrode binder (B) at least partly covers the surface of a particle of the cathode active material (A).

18. The cathode for a lithium ion battery according to claim 17, wherein the particles of the cathode active material have an average degree of coverage of 0.005 to 0.1 g of electrode binder per 0.05 to 0.9 m² of surface area, or 0.05 to 1 g of electrode binder per 10 to 15 m² of surface area.

19. The cathode for a lithium ion battery according to claim 11, comprising, based on the total weight of the cathode:
(A) 80-98% by weight, of at least one cathode active material selected from the group consisting of lithium cobalt oxide (LCO), lithium nickel oxide (LNO), lithium nickel cobalt aluminum oxide (NCA), lithium nickel manganese cobalt oxide (NMC), lithium-and manganese-rich lithium nickel manganese cobalt oxide or lithium nickel manganese oxide (LMR), lithium manganese oxide (LMO), lithium iron phosphate (LFP), lithium manganese iron phosphate (LMFP), lithium nickel manganese oxide spinel (LNMO), derivatives thereof, and combinations thereof;
(B) 0.5-3% by weight, of at least one electrode binder;
(C) 0.05-5% by weight, of at least one conductivity additive selected from the group consisting of conductive carbon black, carbon nanotubes (CNTs), graphene, graphite, expanded graphite, carbon nanofibers, and combinations thereof; and
(D) 0-10% by weight, of at least one additive selected from the group consisting of binding auxiliary, filler, disperser. adhesion promoter, and combinations thereof,
where the % by weight of components (A) to (D) add up to 100 percent.

20. A lithium ion battery comprising the cathode according to claim 11.

21. The cathode for a lithium ion battery according to claim 17, wherein the particles have a particle size distribution having an average particle diameter within a range from 0.01 μm to 30 μm.

22. The cathode for a lithium ion battery according to claim 21, wherein the particles have a particle size distribution having an average particle diameter within a range from 50 nm to 1000 nm.

23. The cathode for a lithium ion battery according to claim 17, wherein the cathode active material comprises a mixture of electrode binders, each electrode binder comprising a different anchor group.

24. The cathode for a lithium ion battery according to claim 17, further comprising at least one conductivity additive (C) selected from the group consisting of conductive carbon black, carbon nanotubes (CNTs), graphene, graphite, expanded graphite, carbon nanofibers, and combinations thereof.

25. The cathode for a lithium ion battery according to claim 17, further comprising one or more additives (D) selected from the group consisting of binding auxiliary, filler, disperser, and adhesion promoter.

26. The cathode for a lithium ion battery according to claim 19, comprising from 90% to 98% by weight of at least one cathode active material.

27. The cathode for a lithium ion battery according to claim 19, comprising from 1% to 2% by weight of at least one electrode binder.

28. The cathode for a lithium ion battery according to claim 19, comprising from 0.5% to 3% by weight of at least one conductivity additive.

29. The cathode for a lithium ion battery according to claim 19, wherein the at least one conductivity additive comprises gas phase produced carbon nanofibers (VGCF).

30. The cathode for a lithium ion battery according to claim 19, comprising from 0.1% to 1% by weight of at least one additive.
